(19) United States
(12) Patent Application Publication
(10) Pub. No.: US 2026/0040327 A1
(43) Pub. Date: Feb. 5, 2026

(54) SYSTEM AND METHOD OF DETERMINING CHANNEL ACCESS PRIORITY FOR SIDELINK COMMUNICATION ON UNLICENSED CARRIER

(71) Applicant: SAMSUNG ELECTRONICS CO., LTD., Suwon-si, Gyeonggi-do (KR)

(72) Inventors: Anil AGIWAL, Suwon-si (KR); Hyunjeong KANG, Suwon-si (KR)

(21) Appl. No.: 18/996,572

(22) PCT Filed: Sep. 27, 2023
(86) PCT No.: PCT/KR2023/015007

§ 371 Date: Jan. 17, 2025

(30) Foreign Application Priority Data
Sep. 28, 2022 (KR) 10-2022-0123733

(51) Int. Cl. H04W 72/25; H04W 74/0808

(52) U.S. Cl. CPC H04W 72/25; H04W 74/0808

(57) ABSTRACT

A method performed by a user equipment (UE) in a wireless communication system is provided. The method includes identifying a channel access priority class (CAPC) for sidelink, and performing a channel access procedure for transmitting a sidelink transport block (TB), based on the CAPC for the sidelink, wherein the CAPC for the sidelink is determined as one of: a highest priority CAPC based on a sidelink medium access control control element (MAC CE) included in the sidelink TB, the highest priority CAPC based on a sidelink control channel (SCCH) service data unit (SDU) included in the sidelink TB, or a lowest priority CAPC of at least one sidelink logical channel with MAC SDU multiplexed in the sidelink TB.

### TECHNICAL FIELD

The disclosure relates to a wireless communication system. Specifically, the disclosure relates to an apparatus, a method and a system for determining channel access priority for sidelink communication on unlicensed carrier.

### BACKGROUND ART

5th generation (5G) mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadband, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure provides a method and an apparatus for determining channel access priority for sidelink communication on unlicensed carrier.

The disclosure further provides a method and an apparatus for performing a channel access procedure for sidelink transmission.

The technical problems to be achieved in the embodiment of the disclosure are not limited to the technical problems mentioned above, and other technical problems not mentioned herein will be clearly understood from the following description by those skilled in the art to which the disclosure belongs.

### Solution to Problem

According to an aspect of the disclosure, a method performed by a UE in a wireless communication system is provided. The method includes identifying a channel access priority class (CAPC) for sidelink, and performing a channel access procedure for transmitting a sidelink transport block (TB), based on the CAPC for the sidelink, wherein the CAPC for the sidelink is determined as one of: a highest priority CAPC based on a sidelink medium access control control element (MAC CE) included in the sidelink TB, the highest priority CAPC based on a sidelink control channel (SCCH) service data unit (SDU) included in the sidelink TB, or a lowest priority CAPC of at least one sidelink logical channel with MAC SDU multiplexed in the sidelink TB.

According to another aspect of the disclosure, a UE in a wireless communication system includes a transceiver, and a processor operably coupled with the transceiver and configured to: identify a CAPC for sidelink, and perform a channel access procedure for transmitting a sidelink TB, based on the CAPC for the sidelink, wherein the CAPC for the sidelink is determined as one of: a highest priority CAPC based on a sidelink MAC CE included in the sidelink TB, the highest priority CAPC based on a SCCH SDU included in the sidelink TB, or a lowest priority CAPC of at least one sidelink logical channel with MAC SDU multiplexed in the sidelink TB.

### Advantageous Effects of Invention

According to an embodiment of the disclosure, a channel access priority class for sidelink communication on unlicensed carrier can be determined/configured.

Further, according to an embodiment of the disclosure, a UE can perform a channel access procedure for sidelink transmission based on the channel access priority class.

Effects that can be obtained in the disclosure are not limited to the above-described effects, and other unmentioned effects will be able to be clearly understood by those of ordinary skill in the art to which the disclosure pertains.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a NG-RAN architecture and supported interfaces according to an embodiment of the disclosure;

FIG. 2 illustrates an example of operations for PSCCH and PSSCH transmission according to an embodiment of the disclosure;

FIG. 3 illustrates another example of operations for PSCCH and PSSCH transmission according to an embodiment of the disclosure;

FIG. 4 illustrates a terminal according to an embodiment of the disclosure; and

FIG. 5 illustrates a base station according to an embodiment of the disclosure.

### MODE FOR THE INVENTION

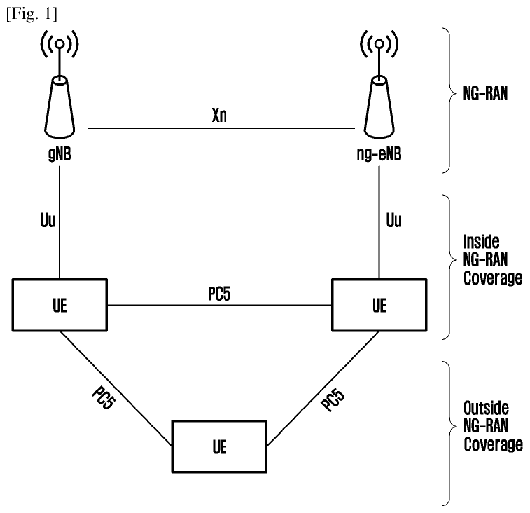

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the disclosure are described with reference to the accompanying drawings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

In the following description, a BS is an entity that allocates resources to terminals, and may be at least one of a gNode B, an eNode B, a Node B, a BS, a wireless access unit, a BS controller, and a node on a network. A terminal may include a UE, a mobile station (MS), a cellular phone, a smartphone, a computer, or a multimedia system capable of performing communication functions.

In the recent years, several broadband wireless technologies have been developed to meet the growing number of broadband subscribers and to provide more and better applications and services. The second-generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive MIMO, FD-MIMO, array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (cMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The mMTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either E-UTRA (i.e. if the node is an ng-eNB) or NR access (i.e. if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the primary cell (PCell) and optionally one or more secondary cells (SCells). In NR the term Secondary Cell Group (SCG) refers to a group of serving cells associated with the Secondary Node, comprising of the primary SCG cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. PSCell refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

In the fifth generation wireless communication system, Physical Downlink Control Channel (PDCCH) is used to schedule DL transmissions on PDSCH and UL transmissions on PUSCH, where the Downlink Control Information (DCI) on PDCCH includes: Downlink assignments containing at least modulation and coding format, resource allocation, and hybrid-ARQ information related to downlink shared channel (DL-SCH); Uplink scheduling grants containing at least modulation and coding format, resource allocation, and hybrid-ARQ information related to uplink shared channel (UL-SCH). In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and OFDM symbol(s) where the UE may assume no transmission is intended for the UE; Transmission of transmit power control (TPC) commands for PUCCH and PUSCH; Transmission of one or more TPC commands for sounding reference signal (SRS) transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DM-RS). Quadrature phase shift keying (QPSK) modulation is used for PDCCH.

In fifth generation wireless communication system, a list of search space configurations are signaled by GNB for each configured BWP wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

$$( y ⋆ number of slots in a radio frame ) + x - Monitoring - offset - \text{} PDCCH - \text{} \text{} slot ) mod ( Monitoring - periodicity - PDCCH - slot ) = 0 ;$$

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations are signaled by GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported subcarrier spacing (SCS) is pre-defined in NR. Each coreset configuration is associated with a list of transmission configuration indicator (TCI) states. One DL RS ID (e.g., SSB or channel state information reference signal (CSI-RS)) is configured per TCI state. The list of TCI states corresponding to a coreset configuration is signaled by gNB via radio resource control (RRC) signaling. One of the TCI state in TCI state list is activated and indicated to UE by gNB. TCI state indicates the DL TX beam (DL TX beam is quasi-co-located (QCLed) with SSB/CSI-RS of TCI state) used by GNB for transmission of PDCCH in the PDCCH monitoring occasions of a search space.

In fifth generation wireless communication system, bandwidth adaptation (BA) is supported. With BA, the receive and transmit bandwidths of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwpInactivityTimer, by RRC signaling, or by the medium access control (MAC) entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

4G and 5G wireless communication system supports vehicular communication services. Vehicular communication services, represented by V2X services, can consist of the following four different types: vehicle-to-vehicle (V2V), vehicle-to-infrastructure (V2I), vehicle-to-network (V2N) and vehicle-to-pedestrian (V2P). In fifth generation (also referred as NR or New Radio) wireless communication system, V2X communication is being enhanced to support enhanced V2X use cases, which are broadly arranged into four use case groups:
1) Vehicles Platooning enables the vehicles to dynamically form a platoon travelling together. All the vehicles in the platoon obtain information from the leading vehicle to manage this platoon. This information allows the vehicles to drive closer than normal in a coordinated manner, going to the same direction and travelling together.
2) Extended Sensors enables the exchange of raw or processed data gathered through local sensors or live video images among vehicles, road site units, devices of pedestrian and V2X application servers. The vehicles can increase the perception of their environment beyond of what their own sensors can detect and have a broader and holistic view of the local situation. High data rate is one of the key characteristics.
3) Advanced Driving enables semi-automated or full-automated driving. Each vehicle and/or road side unit (RSU) shares its own perception data obtained from its local sensors with vehicles in proximity and that allows vehicles to synchronize and coordinate their trajectories or manoeuvres. Each vehicle shares its driving intention with vehicles in proximity too.
4) Remote Driving enables a remote driver or a V2X application to operate a remote vehicle for those passengers who cannot drive by themselves or remote vehicles located in dangerous environments. For a case where variation is limited and routes arc predictable, such as public transportation, driving based on cloud computing can be used. High reliability and low latency are the main requirements.

FIG. 1 illustrates a NG-RAN architecture and supported interfaces according to an embodiment of the disclosure.

V2X services may be provided by PC5 interface and/or Uu interface. Support of V2X services via PC5 interface is provided by NR sidelink communication or V2X sidelink communication, which is a mode of communication whereby UEs can communicate with each other directly over the PC5 interface using NR technology or EUTRA technology respectively without traversing any network node. This communication mode is supported when the UE is served by RAN and when the UE is outside of RAN coverage. Only the UEs authorized to be used for V2X services can perform NR or V2X sidelink communication. The NG-RAN architecture supports the PC5 interface as illustrated in FIG. 1. Sidelink transmission and reception over the PC5 interface are supported when the UE is inside NG-RAN coverage, irrespective of which RRC state the UE is in, and when the UE is outside NG-RAN coverage. Support of V2X services via the PC5 interface can be provided by NR Sidelink Communication and/or V2X Sidelink Communication. NR Sidelink Communication may be used to support other services than V2X services.

NR or V2X Sidelink Communication can support three types of transmission modes. Unicast transmission, characterized by support of at least one PC5-RRC connection between peer UEs; Transmission and reception of control information and user traffic between peer UEs in sidelink; Support of sidelink hybrid automatic repeat request (HARQ) feedback; Support of radio link control (RLC) acknowledge mode (AM); and Support of sidelink radio link monitoring (RLM) for both peer UEs to detect radio link failure (RLF). Groupcast transmission, characterized by: Transmission and reception of user traffic among UEs belonging to a group in sidelink; Support of sidelink HARQ feedback. Broadcast transmission, characterized by: Transmission and reception of user traffic among UEs in sidelink.

The AS protocol stack for the control plane in the PC5 interface consists of RRC, packet data convergence protocol (PDCP), RLC and MAC sublayer, and the physical layer. The AS protocol stack for user plane in the PC5 interface consists of SDAP, PDCP, RLC and MAC sublayer, and the physical layer. Sidelink Radio bearers (SLRB) are categorized into two groups: sidelink data radio bearers (SL DRB) for user plane data and sidelink signalling radio bearers (SL SRB) for control plane data. Separate SL SRBs using different sidelink control channels (SCCHs) are configured for PC5-RRC and PC5-S signaling respectively.

The MAC sublayer provides the following services and functions over the PC5 interface: Radio resource selection; Packet filtering; Priority handling between uplink and sidelink transmissions for a given UE; Sidelink channel state information (CSI) reporting. With logical channel priority (LCP) restrictions in MAC, only sidelink logical channels belonging to the same destination can be multiplexed into a MAC packet data unit (PDU) for every unicast, groupcast and broadcast transmission which is associated to the destination. NG-RAN can also control whether a sidelink logical channel can utilize the resources allocated to a configured sidelink grant Type 1. For packet filtering, a sidelink shared channel (SL-SCH) MAC header including portions of both Source Layer-2 ID and a Destination Layer-2 ID is added to each MAC PDU. A logical channel ID (LCID) included within a MAC subheader uniquely identifies a logical channel within the scope of the Source Layer-2 ID and Destination Layer-2 ID combination. The following logical channels are used in sidelink:
Sidelink Control Channel (SCCH): a sidelink channel for transmitting control information from one UE to other UE(s);
Sidelink Traffic Channel (STCH): a sidelink channel for transmitting user information from one UE to other UE(s);
Sidelink Broadcast Control Channel (SBCCH): a sidelink channel for broadcasting sidelink system information from one UE to other UE(s).

The following connections between logical channels and transport channels exist:
SCCH can be mapped to SL-SCH;
STCH can be mapped to SL-SCH;
SBCCH can be mapped to sidelink broadcast channel (SL-BCH).
Sidelink operation involves the following physical layer channels and signals:
Physical Sidelink Control Channel (PSCCH) indicates resource and other transmission parameters used by a UE for a physical sidelink shared channel (PSSCH). PSCCH transmission is associated with a DM-RS.
PSSCH transmits the transport blocks (TBs) of data themselves, and control information for HARQ procedures and CSI feedback triggers, etc. At least 6 OFDM symbols within a slot are used for PSSCH transmission. PSSCH transmission is associated with a DM-RS and may be associated with a phase tracking reference signal (PT-RS).
Physical Sidelink Feedback Channel (PSFCH) carries HARQ feedback over the sidelink from a UE which is an intended recipient of a PSSCH transmission to the UE which performed the transmission. PSFCH sequence is transmitted in one PRB repeated over two OFDM symbols near the end of the sidelink resource in a slot.
The Sidelink synchronization signal consists of sidelink primary and sidelink secondary synchronization signals (S-PSS, S-SSS), each occupying 2 symbols and 127 subcarriers. Physical Sidelink Broadcast Channel (PSBCH) occupies 9 and 5 symbols for normal and extended CP cases respectively, including the associated DM-RS.
For unicast, channel state information reference signal (CSI-RS) is supported for CSI measurement and reporting in sidelink. A CSI report is carried in a sidelink MAC CE.

The RRC sublayer provides the following services and functions over the PC5 interface:
Transfer of a PC5-RRC message between peer UEs;
Maintenance and release of a PC5-RRC connection between two UEs;
Detection of sidelink radio link failure for a PC5-RRC connection.

A PC5-RRC connection is a logical connection between two UEs for a pair of Source and Destination Layer-2 IDs which is considered to be established after a corresponding PC5 unicast link is established as specified in TS 23.287. There is one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages are used for a UE to transfer UE capability and sidelink configuration including SLRB configuration to the peer UE. Both peer UEs can exchange their own UE capability and sidelink configuration using separate bi-directional procedures in both sidelink directions. If it is not interested in sidelink transmission, if sidelink RLF on the PC5-RRC connection is declared, or if the Layer-2 link release procedure is completed as specified in TS 23.287, UE releases the PC5-RRC connection.

The UE can operate in two modes for resource allocation in sidelink:
Scheduled resource allocation, characterized by:
   The UE needs to be RRC_CONNECTED in order to transmit data;
   NG-RAN schedules transmission resources.
UE autonomous resource selection, characterized by:
   The UE can transmit data when inside NG-RAN coverage, irrespective of which RRC state the UE is in, and when outside NG-RAN coverage;
   The UE autonomously selects transmission resources from a pool of resources. For NR sidelink communication, the UE performs sidelink transmissions only on a single carrier.

Scheduled Resource Allocation: NG-RAN may dynamically allocate resources to the UE via the sidelink-radio network temporary identifier (RNTI) (SL-RNTI) on PDCCH(s) for NR sidelink Communication. In addition, NG-RAN may allocate sidelink resources to UE with two types of configured sidelink grants:
With type 1, RRC directly provides the configured sidelink grant for NR sidelink communication
With type 2, RRC provides the periodicity of the configured sidelink grant while PDCCH can either signal and activate the configured sidelink grant, or deactivate it. The PDCCH provides the actual grant (i.e. resources) to be used. The PDCCH is addressed to sidelink configured scheduling RNTI (SL-CS-RNTI) for NR sidelink communication and sidelink (SL) Semi-Persistent Scheduling V-RNTI for V2X sidelink communication.

For the UE performing NR sidelink communication, there can be more than one configured sidelink grant activated at a time on the carrier configured for sidelink transmission. When beam failure or physical layer problem occurs on NR Uu, the UE can continue using the configured sidelink grant Type 1. During handover, the UE can be provided with configured sidelink grants via handover command, regardless of the type. If provided, the UE activates the configured sidelink grant Type 1 upon reception of the handover command. The UE can send sidelink buffer status report to support scheduler operation in NG-RAN. The sidelink buffer status reports refer to the data that is buffered in for a group of logical channels (LCG) per destination in the UE. Eight LCGs are used for reporting of the sidelink buffer status reports. Two formats, which are SL buffer status report (BSR) and truncated SL BSR, are used.
UE Autonomous Resource Allocation: The UE autonomously selects sidelink grant from a pool of resources provided by broadcast system information or dedicated signalling while inside NG-RAN coverage or by preconfiguration while outside NG-RAN coverage.
For NR sidelink communication, the pools of resources can be provided for a given validity area where the UE does not need to acquire a new pool of resources while moving within the validity area, at least when this pool is provided by system information block (SIB) (e.g. reuse valid area of NR SIB). NR SIB validity mechanism is reused to enable validity area for SL resource pool configured via broadcasted system information. The UE is allowed to temporarily use UE autonomous resource selection with random selection for sidelink transmission based on configuration of the exceptional transmission resource pool.

For V2X sidelink transmission, during handover, transmission resource pool configurations including exceptional transmission resource pool for the target cell can be signaled in the handover command to reduce the transmission interruption. In this way, the UE may use the V2X sidelink transmission resource pools of the target cell before the handover is completed as long as either synchronization is performed with the target cell in case eNB is configured as synchronization source or synchronization is performed with global navigation satellite systems (GNSS) in case GNSS is configured as synchronization source. If the exceptional transmission resource pool is included in the handover command, the UE uses randomly selected resources from the exceptional transmission resource pool, starting from the reception of handover command. If the UE is configured with scheduled resource allocation in the handover command, the UE continues to use the exceptional transmission resource pool while the timer associated with handover is running. If the UE is configured with autonomous resource selection in the target cell the UE continues to use the exceptional transmission resource pool until the sensing results on the transmission resource pools for autonomous resource selection are available. For exceptional cases (e.g. during RLF, during transition from RRC IDLE to RRC CONNECTED or during change of dedicated V2X sidelink resource pools within a cell), the UE may select resources in the exceptional pool provided in serving cell's SIB21 or in dedicated signalling based on random selection, and uses them temporarily. During cell reselection, the RRC_IDLE UE may use the randomly selected resources from the exceptional transmission resource pool of the reselected cell until the sensing results on the transmission resource pools for autonomous resource selection are available.
The design of 5G wireless sidelink communication system needs to support operation on licensed carrier(s) as well as unlicensed carrier(s). Listen-Before-Talk (LBT) procedure is vital for fair and friendly coexistence of devices and technologies operating in unlicensed spectrum. LBT procedures by UE attempting to transmit on a sidelink carrier in unlicensed spectrum require the UE to perform a clear channel assessment to determine if the channel is free for use. The various types or categories of LBT procedures used for sidelink transmission are as follows:
   Type 1: LBT with Random Back-Off with a Contention Window

A UE may transmit the transmission using Type 1 channel access procedure after first sensing the channel to be idle during the slot durations of a defer duration Ta, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration Ta or all the slots of the additional defer duration Ta are detected to be idle;
6) if the channel is sensed to be idle during all the slot durations of the additional defer duration T_{d}, go to step 4; else, go to step 5;

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.
The defer duration Ta consists of duration T_{f}=16 us immediately followed by mₚ consecutive slot durations where each slot duration is Tₛₗ=9 us, and T_{f} includes an idle slot duration Tₛₗ at start of T_{f}.

CW_{min,p}≤CWₚ≤CW_{max,p} is the contention window. CW_{min,p} and CW_{max,p} are chosen before step 1 of the procedure above.
mₚ, CW_{min,p}, and CW_{max,p} are based on a channel access priority class p in Table 1 below.

TABLE 1

| Channel | | | | | |
|---|---|---|---|---|---|
| Access | | | | | |
| Priority | | | | | allowed |
| Class (p) | mₚ | CW_{min, p} | CW_{max, p} | T_{mcot, p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms* | {15, 31, 63} |
| 4 | 7 | 15 | 1023 | 8 or 10 ms* | {15, 31, 63, 127, |
| | | | | | 255, 511, 1023} |

Type 2A: LBT without Random Back-Off

The UE may transmit the transmission immediately after sensing the channel to be idle for at least a sensing interval T_{short_ul}=25 us. T_{short_ul} consists of a duration T (=16 us immediately followed by one slot sensing slot and T_{f} includes a sensing slot at start of T_{f}. The channel is considered to be idle for T_{short_ul} if both sensing slots of T_{short_ul} are sensed to be idle.

### Type 2B:

The UE may transmit the transmission immediately after sensing the channel to be idle within a duration of T_{f}=16 us. T_{f} Includes a sensing slot that occurs within the last 9 us of T_{f}. The channel is considered to be idle within the duration T_{f} if the channel is sensed to be idle for total of at least 5 us with at least 4 us of sensing occurring in the sensing slot.

### Type 2C: No LBT

The UE does not sense the channel before the transmission. The duration of the corresponding UL transmission is at most 584 us.

The issue is which LBT type is used for accessing a channel by UE for the following transmissions on sidelink carrier: PSSCH, PSCCH, PSFCH, S-PSS, S-SSS, or PSBCH.

The issue is that in case Type 1 LBT is used for transmission, how does UE determine the channel access priority class (CAPC) to be used for SL transmission.

### CAPC Determination for PSCCH and PSSCH Transmission by UE

### Embodiment 1

For sidelink communication, UE transmits on PSCCH and PSSCH. PSCCH indicates resource and other transmission parameters used by a UE for PSSCH. PSCCH transmission is associated with a DM-RS. PSSCH transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

Resource for PSCCH and PSSCH may be configured on a carrier belonging to unlicensed spectrum. In this case, UE needs to perform LBT procedure before the transmission to check whether a channel is free or not. If the channel is determined as being free, UE transmits. Otherwise, UE does not transmit. There are several types of LBT procedure (as explained earlier). When LBT type 1 procedure is used before the transmission, UE needs to determine the CAPC for the transmission. There are several CAPCs (e.g., CAPC 1, CAPC 2, CAPC 3, and CAPC 4) wherein each CAPC is associated with different set of parameter values for the parameters needed to perform LBT type 1 procedure. CAPC with lowest value (i.e. CAPC 1) is the highest priority CAPC. CAPC with highest value (i.e. CAPC 4) is the lowest priority CAPC.

In an embodiment of the disclosure, if the SL grant is assigned by gNB in the DCI of PDCCH addressed to SL-RNTI, CAPC for the PSCCH and PSSCH transmission using the SL grant (resources) may be included in the DCI in which the SL grant is received. UE determines the LBT type (or SL channel access type) 1 parameters using the indicated CAPC and performs LBT procedure before the PSCCH and PSSCH transmission using the SL grant. CAPC may be separately indicated for PSCCH and PSSCH, or commonly indicated for both PSCCH and PSSCH in the DCI of PDCCH addressed to SL-RNTI. Note that PSCCH may be NR PSCCH or LTE PSCCH, PSSCH may be NR PSSCH or LTE PSSCH. Indications may be separate or common for LTE and NR. Note that SL channel access type (or LBT Type) may also be included in the DCI.

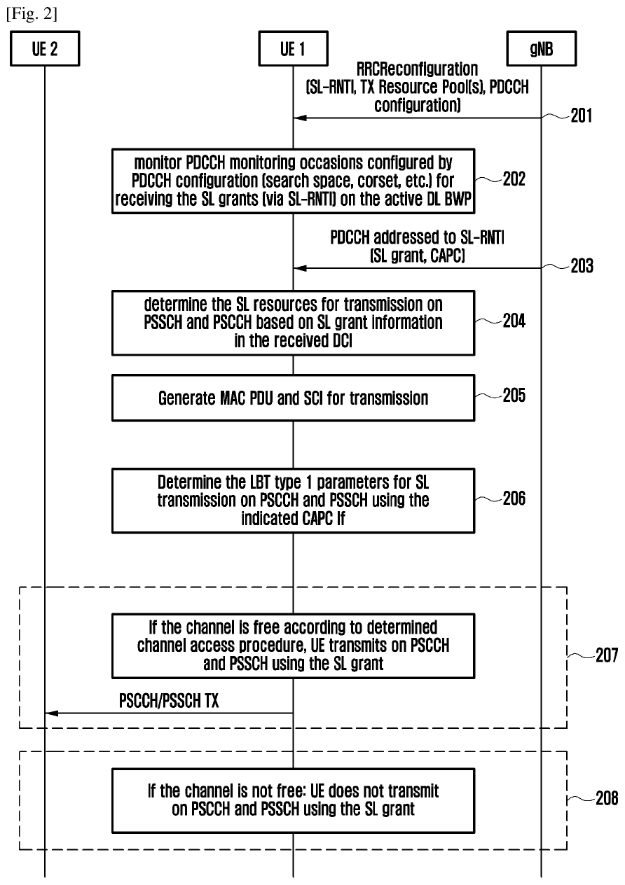

FIG. 2 illustrates an example of operations for PSCCH and PSSCH transmission according to an embodiment of the disclosure. The order of operating steps in FIG. 2 may be changed, some steps may be omitted according to circumstances, or two or more steps may be merged and executed.

Referring to FIG. 2, in step 201, UE 1 is in RRC_CONNECTED state. UE 1 receives RRCReconfiguration message from gNB. RRCReconfiguration message may include a configuration of one or more resource pools which includes the resources by which the UE 1 is allowed to transmit sidelink communication based on network scheduling. The configuration of one or more resource pools indicates resources for PSCCH, PSSCH, and PSFCH. The RRCReconfiguration message may include SL-RNTI and UE specific PDCCH configurations for receiving the SL grants (via SL-RNTI) for sidelink communication. UE specific PDCCH configurations for receiving the SL grants (via SL-RNTI) for sidelink communication is per configured DL BWP.

In step 202, UE 1 monitors PDCCH monitoring occasions configured by PDCCH configuration (e.g., search space, corset, etc.) for receiving the SL grants (via SL-RNTI) on the active DL BWP. PDCCH including DCI for SL grants of sidelink communication is addressed to SL-RNTI (i.e. cyclic redundancy check (CRC) of DCI is masked or scrambled by SL-RNTI).

In step 203, UE 1 receives PDCCH addressed to SL-RNTI in the monitored PDCCH monitoring occasions. The DCI in the PDCCH includes SL grant i.e. scheduling information (e.g. resource pool index, carrier index, HARQ process number, new data indicator, lowest index of subchannel allocation to the initial transmission, PSFCH to HARQ feedback timing indicator, PUCCH resource indicator etc.) for transmission on PSSCH and PSCCH.

In an embodiment, DCI included in PDCCH addressed to SL-RNTI may indicate CAPC.

In step 204, UE 1 determines the SL resources for transmission on PSCCH and PSSCH based on SL grant information in the received DCI.

In step 205, UE 1 generates MAC PDU and SCI for transmission.

In step 206, UE 1 determines the LBT type 1 parameters using the indicated CAPC.

UE performs channel access for transmission on determined SL resources according to SL Channel Access Type 1.

In step 207, if the channel is free according to determined channel access procedure, UE 1 transmits on PSCCH and PSSCH using the SL grant. If PUCCH resources are provided for feedback in the DCI including SL grant, UE 1 may send acknowledgment (ACK)/negative-ack (NACK) based on feedback received from the peer UE (i.e., UE 2) for the transmission.

Otherwise (i.e. if the channel is not free), in step 208, UE 1 does not transmit on PSCCH and PSSCH using the SL grant. In this case, if PUCCH resources are provided for feedback in the DCI including SL grant or in RRCReconfiguration message, UE may send NACK to gNB.

### Embodiment 2

For sidelink communication UE transmits on PSCCH and PSSCH. PSCCH indicates resource and other transmission parameters used by a UE for PSSCH. PSCCH transmission is associated with a DM-RS. PSSCH transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

Resource for PSCCH and PSSCH may be configured on a carrier belonging to unlicensed spectrum. In this case, UE needs to perform LBT procedure before the transmission to check whether a channel is free or not. If the channel is determined as being free, UE transmits. Otherwise, UE does not transmit. There are several types of LBT procedure (as explained earlier). When LBT type 1 procedure is used before the transmission, UE needs to determine the CAPC for the transmission. There are several CAPCs (e.g., CAPC 1, CAPC 2, CAPC 3, and CAPC 4) wherein each CAPC is associated with different set of parameter values for the parameters needed to perform LBT type 1 procedure. CAPC with lowest value (i.e. CAPC 1) is the highest priority CAPC. CAPC with highest value (i.e. CAPC 4) is the lowest priority CAPC.

In an embodiment of the disclosure, if the SL grant i.e. SL configured grant type 2 is assigned by gNB in the DCI of PDCCH addressed to SL-CS-RNTI, CAPC for the PSCCH and PSSCH transmission using the SL grant (resources) may be included in the DCI in which the SL grant is received. UE determines the LBT type 1 parameters using the indicated CAPC and perform LBT procedure before the PSCCH and PSSCH transmission using the SL grant. CAPC may be separately indicated for PSCCH and PSSCH, or commonly indicated for both PSCCH and PSSCH in the DCI of PDCCH addressed to SL-CS-RNTI. Note that PSCCH may be NR PSCCH or LTE PSCCH, PSSCH may be NR PSSCH or LTE PSSCH. Indications may be separate or common for LTE and NR. Note that SL channel access type may also be included in the DCI. Note that CAPC indicated in DCI is applied for each SL grant occurring periodically as per the period indicated in SL configured grant type 2 configuration in RRC Reconfiguration message.

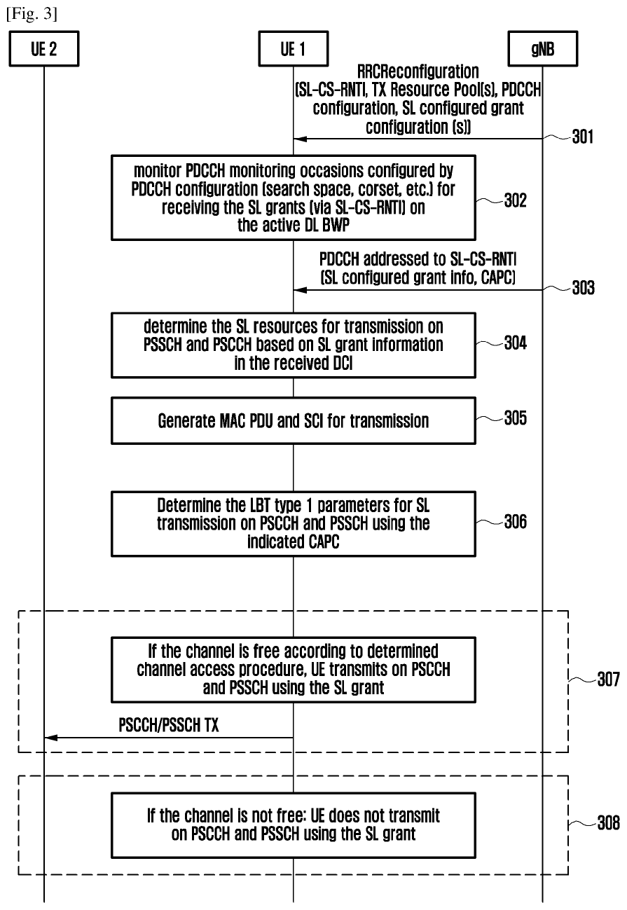

FIG. 3 illustrates another example of operations for PSCCH and PSSCH transmission according to an embodiment of the disclosure. The order of operating steps in FIG. 3 may be changed, some steps may be omitted according to circumstances, or two or more steps may be merged and executed.

Referring to FIG. 3, in step 301, UE 1 is in RRC_CONNECTED state. UE 1 receives RRCReconfiguration message from gNB. RRCReconfiguration message may include a configuration of one or more resource pools which includes the resources by which the UE 1 is allowed to transmit sidelink communication based on network scheduling. The configuration of one or more resource pools indicates resources for PSCCH, PSSCH, and PSFCH. The RRCReconfiguration message may include SL-CS-RNTI and UE specific PDCCH configurations for receiving the SL grants (via SL-CS-RNTI) for sidelink communication. UE specific PDCCH configurations for receiving the SL grants (via SL-CS-RNTI) for sidelink communication is per configured DL BWP. RRCReconfiguration message may include one or more configurations of sidelink configured grant type 2 for sidelink communication on the configured sidelink BWP on a carrier. Each configuration is identified by a configuration index and includes periodicity of SL configured grant.

In step 302, UE 1 monitors PDCCH monitoring occasions configured by PDCCH configuration (e.g., search space, corset, etc.) for receiving the SL grants (via SLCS-RNTI) on the active DL BWP. PDCCH including DCI for SL grants of sidelink communication is addressed to SL-CS-RNTI (i.e. CRC of DCI is masked or scrambled by SL-CS-RNTI).

In step 303, UE 1 receives PDCCH addressed to SL-CS-RNTI in the monitored PDCCH monitoring occasions. The DCI (e.g. DCI format 3_0) in the PDCCH includes scheduling information (e.g. resource pool index, carrier index, HARQ process number, new data indicator, lowest index of subchannel allocation to the initial transmission, PSFCH to HARQ feedback timing indicator, PUCCH resource indicator, Configuration index etc.) for transmission on PSSCH and PSCCH. In an embodiment, DCI included in PDCCH addressed to SL-CS-RNTI may indicate CAPC.

In step 304, UE 1 determines the SL resources for transmission on PSCCH and PSSCH based on SL grant information in the received DCI. SL grant may occur periodically as per the period indicated in SL configured grant type 2 configuration in RRC Reconfiguration message.

In step 305, UE 1 generates MAC PDU and SCI for transmission.

In step 306, UE 1 determines the LBT type 1 parameters using the indicated CAPC. UE 1 performs channel access for transmission on determined SL resources according to SL channel access type 1.

In step 307, if the channel is free according to determined channel access procedure, UE 1 transmits on PSCCH and PSSCH using the SL grant.

Otherwise (i.e. if the channel is not free), in step 308, UE 1 does not transmit on PSCCH and PSSCH using the SL grant.

### Embodiment 3

For sidelink communication, UE transmits on PSCCH and PSSCH. PSCCH indicates resource and other transmission parameters used by a UE for PSSCH. PSCCH transmission is associated with a DM-RS. PSSCH transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

Resource for PSCCH and PSSCH may be configured on a carrier belonging to unlicensed spectrum. In this case, UE needs to perform LBT procedure before the transmission to check whether a channel is free or not. If the channel is determined as being free, UE transmits. Otherwise, UE does not transmit. There are several types of LBT procedure (as explained earlier). When LBT type 1 procedure is used before the transmission, UE needs to determine the CAPC for the transmission. There are several CAPCs (e.g., CAPC 1, CAPC 2, CAPC 3, and CAPC 4) wherein each CAPC is associated with different set of parameter values for the parameters needed to perform LBT type 1 procedure. CAPC with lowest value (i.e. CAPC 1) is the highest priority CAPC. CAPC with highest value (i.e. CAPC 4) is the lowest priority CAPC.

In an embodiment of the disclosure, CAPC for the PSCCH and PSSCH transmission may be indicated or signaled by gNB in the RRCReconfiguration message. UE determines the LBT type 1 parameters using the indicated CAPC and performs LBT procedure before the PSCCH and PSSCH transmission using the SL grant. CAPC may be separately indicated for PSCCH and PSSCH, or commonly indicated for both PSCCH and PSSCH in the RRCReconfiguration message. Note that PSCCH may be NR PSCCH or LTE PSCCH, PSSCH may be NR PSSCH or LTE PSSCH. Indications may be separate or common for LTE and NR.

In an alternate embodiment of the disclosure, CAPC for the PSCCH and PSSCH transmission may be indicated or signaled by gNB in the system information (e.g. in the SIB providing the SL configurations). UE determines the LBT type 1 parameters using the indicated CAPC and performs LBT procedure before the PSCCH and PSSCH transmission using the SL grant. CAPC may be separately indicated for PSCCH and PSSCH, or commonly indicated for both PSCCH and PSSCH in the system information. Note that PSCCH may be NR PSCCH or LTE PSCCH, PSSCH may be NR PSSCH or LTE PSSCH. Indications may be separate or common for LTE and NR.

In an alternate embodiment of the disclosure, CAPC for the PSCCH and PSSCH transmission may be indicated or signaled by gNB in the system information (e.g. in the SIB providing the SL configurations) or RRC Reconfiguration message per TX resource pool or commonly signaled for all mode 1 TX resource pools or mode 2 TX resource pools. UE determines the LBT type 1 parameters using the indicated CAPC corresponding to resource pool of SL grant and performs LBT procedure before the PSCCH and PSSCH transmission using the SL grant. CAPC may be separately indicated for PSCCH and PSSCH, or commonly indicated for both PSCCH and PSSCH. Note that PSCCH may be NR PSCCH or LTE PSCCH, PSSCH may be NR PSSCH or LTE PSSCH. Indications may be separate or common for LTE and NR. Note that resources of SL grant corresponds to a resource pool wherein resource pool index is indicated in DCI for dynamic SL grant and SL configured grant type1, resource pool index for SL configured grant type 1 is indicated in SL configured grant type 1 configuration.

In an alternate embodiment of the disclosure, CAPC for the PSCCH and PSSCH transmission may be indicated or signaled by gNB in the system information (e.g. in the SIB providing the SL configurations) or RRC Reconfiguration message per destination layer 2 ID. UE determines the LBT type 1 parameters using the indicated CAPC corresponding to destination layer 2 ID of UE to which MAC PDU/SCI are to be transmitted using the SL grant. UE then performs LBT procedure before the PSCCH and PSSCH transmission using the SL grant. CAPC may be separately indicated for PSCCH and PSSCH, or commonly indicated for both PSCCH and PSSCH. Note that PSCCH may be NR PSCCH or LTE PSCCH, PSSCH may be NR PSSCH or LTE PSSCH. Indications may be separate or common for LTE and NR.

In an alternate embodiment of the disclosure, CAPC for the PSCCH and PSSCH transmission may be indicated or signaled by gNB in the system information (e.g. in the SIB providing the SL configurations) or RRC Reconfiguration message per scheduling mode (e.g., mode 1, mode 2). UE determines the LBT type 1 parameters using the indicated CAPC corresponding to scheduling mode associated with the SL grant. UE then performs LBT procedure before the PSCCH and PSSCH transmission using the SL grant. CAPC may be separately indicated for PSCCH and PSSCH, or commonly indicated for both PSCCH and PSSCH. Note that PSCCH may be NR PSCCH or LTE PSCCH, PSSCH may be NR PSSCH or LTE PSSCH. Indications may be separate or common for LTE and NR.

In an alternate embodiment of the disclosure, CAPC for the PSCCH and PSSCH transmission may be indicated or signaled by gNB in the system information (e.g. in the SIB providing the SL configurations) or RRC Reconfiguration message per SL configured grant configuration. UE determines the LBT type 1 parameters using the indicated CAPC corresponding to SL configured grant configuration associated with the SL grant. UE then performs LBT procedure before the PSCCH and PSSCH transmission using the SL grant. CAPC may be separately indicated for PSCCH and PSSCH, or commonly indicated for both PSCCH and PSSCH. Note that PSCCH may be NR PSCCH or LTE PSCCH, PSSCH may be NR PSSCH or LTE PSSCH. Indications may be separate or common for LTE and NR.

In an alternate embodiment of the disclosure, CAPC for the PSCCH and PSSCH transmission may be indicated or signaled by gNB in the system information (e.g. in the SIB providing the SL configurations) or RRC Reconfiguration message per a cast type (e.g., unicast, broadcast and groupcast). UE determines the LBT type 1 parameters using the indicated CAPC corresponding to the cast type to which MAC PDU/SCI are to be transmitted using the SL grant. UE then performs LBT procedure before the PSCCH and PSSCH transmission using the SL grant. CAPC may be separately indicated for PSCCH and PSSCH or commonly indicated for both PSCCH and PSSCH. Note that PSCCH may be NR PSCCH or LTE PSCCH, PSSCH may be NR PSSCH or LTE PSSCH. Indications may be separate or common for LTE and NR.

### Embodiment 4

For sidelink communication, UE transmits on PSCCH and PSSCH. PSCCH indicates resource and other transmission parameters used by a UE for PSSCH. PSCCH transmission is associated with a DM-RS. PSSCH transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

Resource for PSCCH and PSSCH may be configured on a carrier belonging to unlicensed spectrum. In this case, UE needs to perform LBT procedure before the transmission to check whether a channel is free or not. If the channel is determined as being free, UE transmits. Otherwise, UE does not transmit. There are several types of LBT procedure (as explained earlier). When LBT type 1 procedure is used before the transmission, UE needs to determine the CAPC for the transmission. There are several CAPCs (e.g., CAPC 1, CAPC 2, CAPC 3, and CAPC 4) wherein each CAPC is associated with different set of parameter values for the parameters needed to perform LBT type 1 procedure. CAPC with lowest value (i.e. CAPC 1) is the highest priority CAPC. CAPC with highest value (i.e. CAPC 4) is the lowest priority CAPC.

If CAPC is not explicitly signaled (e.g. in DCI or system information or RRC message) for the transmission by gNB, UE may determine CAPC for transmission based on a content of SL MAC PDU to be transmitted on PSSCH as follows:
Option 1: The lowest priority CAPC of the Sidelink logical channel(s) with SL MAC service data unit (SDU) and SL MAC CEs multiplexed in the TB is used. SL MAC PDU to be transmitted on PSSCH may include SL MAC SDU(s) and/or SL MAC CE(s). Each SL MAC SDU is associated with a sidelink logical channel identified by LCID. Each SL MAC CE is associated with a sidelink logical channel identified by LCID. UE identifies the CAPC of each SL MAC SDU/SL MAC CE included in the SL MAC PDU. UE then uses the lowest priority CAPC (i.e. CAPC with highest index or value) amongst all the identified CAPCs.
Option 2: The lowest priority CAPC of the Sidelink logical channel(s) with SL MAC SDU multiplexed in the TB is used. SL MAC PDU to be transmitted on PSSCH include SL MAC SDU(s). It may or may not include SL MAC CE(s). Each SL MAC SDU is associated with a sidelink logical channel identified by LCID. Each SL MAC CE is associated with a sidelink logical channel identified by LCID. UE identifies the CAPC of each SL MAC SDU included in the SL MAC PDU. UE then uses the lowest priority CAPC (i.e. CAPC with highest index or value) amongst all the identified CAPCs. Note that in this option UE does not identify CAPC of SL MAC CEs included in the SL MAC PDU. In an embodiment, this option is used when SL MAC PDU docs not include SL MAC CE(s).
Option 3: if only SL MAC CEs are included in the SL TB, the highest priority CAPC of those SL MAC CE(s) is used: SL MAC PDU to be transmitted on PSSCH include SL MAC CE(s). It does not include SL MAC SDUs(s). Each SL MAC CE is associated with a sidelink logical channel identified by LCID. UE identifies the CAPC of each SL MAC CE included in the SL MAC PDU. UE then uses the highest priority CAPC (i.e. CAPC with lowest index or value) amongst all the identified CAPCs.
Option 4: If SCCH SL MAC SDUs are included in the SL TB, the highest priority CAPC of SCCH(s) is used: SL MAC PDU to be transmitted on PSSCH include SL MAC SDU(s). It may or may not include SL MAC CE(s). Each SL MAC SDU is associated with a sidelink logical channel identified by LCID. Each SL MAC CE is associated with a sidelink logical channel identified by LCID. UE checks whether there is at least one SL MAC SDU corresponding to SCCH included in the SL MAC PDU. If there is at least one SL MAC SDU corresponding to SCCH included in the SL MAC PDU, UE identifies the CAPC of each SL MAC SDU corresponding to SCCH. UE then uses the highest priority CAPC (i.e. CAPC with lowest index or value) amongst all the identified CAPCs. In case CAPC is same for all SCCH and if SCCH SL MAC SDU(s) are included in the SL TB, the CAPC of SCCH is used.
Option 5: if SCCH SL MAC SDUs for certain LCID (e.g. LCID 0, LCID 1) are included in the SL TB, the highest priority CAPC of these SCCH(s) is used: SL MAC PDU to be transmitted on PSSCH include SL MAC SDU(s). It may or may not include SL MAC CE(s). Each SL MAC SDU is associated with a sidelink logical channel identified by LCID. Each SL MAC CE is associated with a sidelink logical channel identified by LCID. UE checks whether there is at least one SL MAC SDU corresponding to SCCH for certain LCIDs (Certain LCID may be one or more from LCID 0, 1, 2, 3, 56, 57, 58) included in the SL MAC PDU. If there is at least one SL MAC SDU corresponding to SCCH for certain LCIDs included in the SL MAC PDU, UE identifies their CAPCs. UE then uses the highest priority CAPC (i.e. CAPC with lowest index or value) amongst all the identified CAPCs.
Option 6: if SCCH SL MAC SDUs for certain LCID (e.g. LCID 0, LCID 1) are included in the SL TB, the highest priority CAPC is used: SL MAC PDU to be transmitted on PSSCH include SL MAC SDU(s). It may or may not include SL MAC CE(s). Each SL MAC SDU is associated with a sidelink logical channel identified by LCID. Each SL MAC CE is associated with a sidelink logical channel identified by LCID. UE checks whether there is at least one SL MAC SDU corresponding to SCCH for certain LCIDs (Certain LCID may be one or more from LCID 0, 1, 2, 3, 56, 57, 58) included in the SL MAC PDU. If there is at least one SL MAC SDU corresponding to SCCH for certain LCIDs included in the SL MAC PDU, UE uses the highest priority CAPC (i.e. CAPC with lowest index or value i.e. CAPC 1).
Option 7: if certain SL MAC CE is included in MAC PDU, highest priority CAPC is used: SL MAC PDU to be transmitted on PSSCH include SL MAC SDU(s) and/or SL MAC CE(s). Each SL MAC SDU is associated with a sidelink logical channel identified by LCID. Each SL MAC CE is associated with a sidelink logical channel identified by LCID. UE checks whether a specific SL MAC CE is included in the SL MAC PDU. If a specific SL MAC CE is included in the SL MAC PDU, UE uses the highest priority CAPC (i.e. CAPC with lowest index or value i.e. CAPC 1). The specific SL MAC CE may be pre-defined or signalled by gNB in RRC message or SI or in pre-configured SL configuration. The specific SL MAC CE may be Sidelink CSI Reporting MAC CE or Sidelink Inter-UE Coordination Request MAC CE and Sidelink Inter-UE Coordination Information MAC CE or Sidelink discontinuous reception (DRX) Command MAC CE.
Option 8: if certain SL DRB (or SRB) MAC SDU is included in MAC PDU, highest priority CAPC is used: SL MAC PDU to be transmitted on PSSCH includes SL MAC SDU(s) and/or SL MAC CE(s). Each SL MAC SDU is associated with a sidelink logical channel identified by LCID. Each SL MAC CE is associated with a sidelink logical channel identified by LCID. Sidelink SRB(s) and sidelink DRB(s) are mapped to sidelink logical channels. UE checks whether a specific SL DRB(s)/SRB(s) MAC SDU (i.e. MAC SDU for logical channel of specific SRB/DRB) is included in the SL MAC PDU. If yes, UE uses the highest priority CAPC (i.e. CAPC with lowest index or value i.e. CAPC 1). Specific SL DRB(s)/SL SRB(s) may be pre-defined or signalled by gNB in RRC message or SI or in pre-configured SL configuration.

In the above operation, UE needs to CAPC associated with sidelink logical channels/SRBs/DRBs/MAC CEs. There are two types of sidelink logical channels, SCCH and STCH. SCCH carries signalling messages. Various logical channels for SCCH are as follows:
LCID 0 (SL-SRB0): SCCH carrying PC5-S messages that are not protected. For LCID 0, CAPC may be determined as follows:
   CAPC may be pre-defined; CAPC may be signalled by gNB in RRC or SI or pre-configured SL configuration; CAPC may be the highest priority CAPC; or CAPC may be the lowest priority CAPC.
LCID 1 (SL-SRB1): SCCH carrying PC5-S messages, direct security mode command, direct security mode complete. For LCID 1, CAPC may be determined as follows:
   CAPC may be pre-defined; CAPC may be signalled by gNB in RRC or SI or pre-configured SL configuration; CAPC may be the highest priority CAPC; or CAPC may be the lowest priority CAPC.
LCID 2 (SL-SRB2): SCCH carrying other PC5-S messages that are protected. For LCID 2, CAPC may be determined as follows:
   CAPC may be pre-defined; CAPC may be signalled by gNB in RRC or SI or pre-configured SL configuration; CAPC may be the highest priority CAPC; or CAPC may be the lowest priority CAPC.
LCID 3 (SL-SRB3): SCCH carrying PC5-RRC messages. For LCID 3, CAPC may be determined as follows:
   CAPC may be pre-defined; CAPC may be signalled by gNB in RRC or SI or pre-configured SL configuration; CAPC may be the highest priority CAPC; or CAPC may be the lowest priority CAPC.
LCID 56: SCCH carrying PC5-RRC messages delivered via SL-RLC0. For LCID 56, CAPC may be determined as follows:
   CAPC may be pre-defined; CAPC may be signalled by gNB in RRC or SI or pre-configured SL configuration; CAPC may be the highest priority CAPC; or CAPC may be the lowest priority CAPC.
LCID 57: SCCH carrying PC5-RRC messages delivered via SL-RLC 1. For LCID 57, CAPC may be determined as follows:
   CAPC may be pre-defined; CAPC may be signalled by gNB in RRC or SI or pre-configured SL configuration; CAPC may be the highest priority CAPC; or CAPC may be the lowest priority CAPC.
LCID 58 (SL-SRB4): SCCH carrying discovery messages. For LCID 58, CAPC may be determined as follows:
   CAPC may be pre-defined; CAPC may be signalled by gNB in RRC or SI or pre-configured SL configuration; CAPC may be the highest priority CAPC; or CAPC may be the lowest priority CAPC.

In an embodiment, CAPC may be fixed to highest priority CAPC for all of the above SCCHs.

In an embodiment, CAPC may be fixed to highest priority for some of them (e.g. for LCID 0 and LCID 1). For others, it is configurable by network (e.g. in SI or pre configuration) or set to the lowest priority CAPC.

In an embodiment, CAPC may be configurable by network (e.g. in SI or pre configuration) for all of them. In an embodiment, CAPC of SL-SRB0, SL-SRB1, SLSRB2 and SL-SRB3 may be set to highest priority CAPC i.e. CAPC1 and CAPC of SL-SRB4 may be set to lowest priority CAPC i.e. CAPC4.

CAPC for SL MAC CEs may be determined as follows:
Sidelink CSI Reporting MAC CE: CAPC may be the highest priority CAPC; CAPC may be the lowest priority CAPC; or CAPC may be signalled by gNB in RRC or SI or pre-configured SL configuration.
Sidelink Inter-UE Coordination Request MAC CE and Sidelink Inter-UE Coordination Information MAC CE: CAPC may be the highest priority CAPC; CAPC may be the lowest priority CAPC; or CAPC may be signalled by gNB in RRC or SI or preconfigured SL configuration.
Sidelink DRX Command MAC CE: CAPC may be the highest priority CAPC; CAPC may be the lowest priority CAPC; or CAPC may be signalled by gNB in RRC or SI or pre-configured SL configuration.

Logical channels of STCH are for SL DRBs. Each SL DRB is associated with sidelink LCID.

CAPC for each SL DRB or corresponding SL logical channel (LCH) may be signalled by gNB in RRC or SI or pre-configured SL configuration.
In an embodiment, CAPC may be signalled per sidelink PC5 quality of service (QoS) identifier (SL-PQI) by gNB in RRC or SI or pre-configured SL configuration, or mapping between CAPC and SL-PQIs may be pre-defined. Based on SL-PQI of a SL-DRB, CAPC of SL-DRB is the CAPC of associated SL-PQI. CAPC of SL LCH associated with SL-DRB is the CAPC of SL-PQI associated with that SL DRB. SL-PQI associated with SL DRB is signalled by gNB in RRC or SI or pre-configured SL configuration.
In an embodiment, CAPC may be signalled per SL-priority by gNB in RRC or SI or pre-configured SL configuration, or mapping between CAPC and SL-priority may be pre-defined. Based on SL-priority of a SL-DRB, CAPC of SL-DRB is the CAPC of associated SL-priority. CAPC of SL LCH associated with SL-DRB is the CAPC of SL-priority associated with that LCH.

This method may also be used for SL SRBs.

CAPC for PSCCH:
In an embodiment, it may be same as corresponding PSSCH.
In an embodiment, it may be signalled by gNB in RRC or SI or pre-configured SL configuration.
In an embodiment, it may be set to highest priority i.e. CAPC 1.
In an embodiment, it may be set to lowest priority i.e. CAPC 4.
In an embodiment, it may be configured by network in same manner as PSSCH.

CAPC for PSFCH:
In an embodiment, it may be signaled by TX UE to RX UE in SCI.
In an embodiment, it may be signalled by gNB in RRC or SI or pre-configured SL configuration.
In an embodiment, it may be set to highest priority i.e. CAPC 1.
In an embodiment, it may be set to lowest priority i.e. CAPC 4.
In an embodiment, it may be configured by network in same manner as PSSCH.

CAPC for S-PSS/S-SSS/PSBCH:
In an embodiment, it may be signalled by gNB in RRC or SI or pre-configured SL configuration.
In an embodiment, it may be set to highest priority i.e. CAPC 1.
In an embodiment, it may be set to lowest priority i.e. CAPC 4.

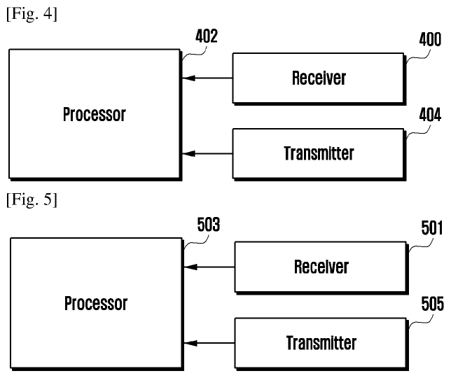

FIG. 4 illustrates a terminal according to an embodiment of the disclosure.

Referring to FIG. 4, the terminal includes a receiver 400, a transmitter 404, and a processor 402. The receiver 400 and the transmitter 404 may be commonly referred to as a transceiver. The transceiver may transmit and receive a signal to and from a BS. The signal may include control information and data. To this end, the transceiver may include a radio frequency (RF) transmitter that up-converts and amplifies the frequency of a transmitted signal, an RF receiver that low-noise amplifies a received signal and down-converts the frequency, etc. Further, the transceiver may receive a signal through a wireless channel, output the signal to the processor 402, and transmit the signal output from the processor 402 through a wireless channel.

The processor 402 may control a series of processes so that the terminal operates according to embodiments of the disclosure. For example, the processor 402 may control operations for the terminal to determine CAPC and perform channel access procedure for sidelink transmission according to the above-described embodiment of the disclosure.

FIG. 5 illustrates a base station according to an embodiment of the disclosure.

Referring to FIG. 5, the base station includes a receiver 501, a transmitter 505, and a processor 503. The receiver 501 and the transmitter 505 may commonly be referred to as a transceiver. The transceiver may transmit and receive a signal to and from the terminal. The signal may include control information and data. To this end, the transceiver may include an RF transmitter that up-converts and amplifies the frequency of a transmitted signal, an RF receiver that low-noise amplifies a received signal and down-converts the frequency, etc. Further, the transceiver may receive a signal through a wireless channel, output the signal to the processor 503, and transmit the signal output from the processor 503 through a wireless channel.

The processor 503 may control a series of processes so that the base station operates according to embodiments of the disclosure. For example, the processor 503 may control operations of the base station associated with CAPC determination and a channel access procedure for sidelink transmission according to the above-described embodiment of the disclosure.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a RAM and a flash memory, a ROM, an electrically erasable programmable read only memory (EEPROM), a magnetic disc storage device, a CDROM, DVDs, other type optical storage devices, or a magnetic cassette. Alternatively, any combination of some or all of the memory devices may form a memory in which the program is stored. Further, a plurality of such memories may be included in the electronic device.

In addition, the programs may be stored in an attachable storage device which may access the electronic device through communication networks such as the Internet, Intranet, a local area network (LAN), a wide LAN (WLAN), and a storage area network (SAN) or a combination thereof. Such a storage device may access the electronic device via an external port. Further, a separate storage device on the communication network may access a portable electronic device.

The embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other modifications and changes may be made thereto on the basis of the technical idea of the disclosure. Further, the above respective embodiments may be employed in combination, as necessary. For example, one embodiment of the disclosure may be partially combined with other embodiments to operate a BS and a terminal. As an example, embodiments of the disclosure described herein may be combined with each other to operate a BS and a terminal.

In the drawings in which methods of the disclosure are described, the order of the description does not always correspond to the order in which steps of each method are performed, and the order or relationship between the steps may be changed or the steps may be performed in parallel.

Alternatively, in the drawings in which methods of the disclosure are described, some elements may be omitted and only some elements may be included therein without departing from the essential spirit and scope of the disclosure.

Further, in methods of the disclosure, some or all of the contents of each embodiment may be combined without departing from the scope of the disclosure.

Various embodiments of the disclosure have been described. The above description of the disclosure is used for exemplification, and the embodiments of the disclosure are not limited to the disclosed embodiments. Those skilled in the art would understand that the disclosure can be easily modified to other detailed forms without changing the technical idea or an essential feature thereof. The scope of the disclosure is represented by the claims to be described below rather than the detailed description, and it is to be interpreted that the meaning and scope of the claims and all the changes or modified forms derived from the equivalents thereof fall within the scope of the disclosure.

1. A method performed by a user equipment (UE) in a wireless communication system, the method comprising:
identifying a channel access priority class (CAPC) for sidelink; and
performing a channel access procedure for transmitting a sidelink transport block (TB), based on the CAPC for the sidelink,
wherein the CAPC for the sidelink is determined as one of:
a highest priority CAPC based on a sidelink medium access control control element (MAC CE) included in the sidelink TB,
the highest priority CAPC based on a sidelink control channel (SCCH) service data unit (SDU) included in the sidelink TB, or
a lowest priority CAPC of at least one sidelink logical channel with MAC SDU multiplexed in the sidelink TB.

2. The method of claim 1,
wherein the highest priority CAPC is used for a sidelink broadcast control channel (SBCCH) SDU transmission and a physical sidelink feedback channel (PSFCH) transmission.

3. The method of claim 1,
wherein a CAPC for a sidelink signaling radio bearer (SRB) is fixed to a highest priority for all sidelink SRBs.

4. The method of claim 1,
wherein a CAPC for a sidelink data radio bearer (DRB) is configurable per each DRB for all sidelink DRBs.

5. The method of claim 1, wherein performing the channel access procedure comprises performing a type 1 listen before talk (LBT) procedure.

6. The method of claim 1, further comprising:
transmitting a physical sidelink control channel (PSCCH) or a physical sidelink shared channel (PSSCH) based on the channel access procedure.

7. The method of claim 1, further comprising:
receiving downlink control channel (DCI), wherein cyclic redundancy check (CRC) of the DCI is scrambled by sidelink-radio network temporary identifier (SL-RNTI) or sidelink configured scheduling RNTI (SL-CS-RNTI).

8. The method of claim 1,
wherein the CAPC is associated with one of a cast type, a destination layer 2 identifier, a transmission resource pool, or priority.

9. The method of claim 1,
wherein in case that the CAPC for the sidelink is not included in downlink control information (DCI), the CAPC for the sidelink is determined as the one.

10. A user equipment (UE) in a wireless communication system, the UE comprising:
a transceiver; and
a processor operably coupled with the transceiver and configured to:
identify a channel access priority class (CAPC) for sidelink, and
perform a channel access procedure for transmitting a sidelink transport block (TB), based on the CAPC for the sidelink,
wherein the CAPC for the sidelink is determined as one of:
a highest priority CAPC based on a sidelink medium access control control element (MAC CE) included in the sidelink TB,
the highest priority CAPC based on a sidelink control channel (SCCH) service data unit (SDU) included in the sidelink TB, or a lowest priority CAPC of at least one sidelink logical channel with MAC SDU multiplexed in the sidelink TB.

11. The UE of claim 10,
wherein the highest priority CAPC is used for a sidelink broadcast control channel (SBCCH) SDU transmission and a physical sidelink feedback channel (PSFCH) transmission.

12. The UE of claim 10,
wherein a CAPC for a sidelink signaling radio bearer (SRB) is fixed to a highest priority for all sidelink SRBs.

13. The UE of claim 10,
wherein a CAPC for a sidelink data radio bearer (DRB) is configurable per each DRB for all sidelink DRBs.

14. The UE of claim 10,
wherein the processor is configured to perform a type 1 listen before talk (LBT) procedure, for performing the channel access procedure.

15. The UE of claim 10, wherein the processor is further configured to:
receive downlink control information (DCI), wherein cyclic redundancy check (CRC) of the DCI is scrambled by sidelink-radio network temporary identifier (SL-RNTI) or sidelink configured scheduling RNTI (SL-CS-RNTI), and
transmit a physical sidelink control channel (PSCCH) or a physical sidelink shared channel (PSSCH) based on the channel access procedure.
